(19) United States
(12) Patent Application Publication
(10) Pub. No.: US 2010/0102936 A1
(43) Pub. Date: Apr. 29, 2010

(54) REMOTELY CONTROLLABLE POWER SWITCH OF AN APPLIANCE AND METHODS OF EMPLOYING THE SAME

(75) Inventors: Christopher A. White, Neshanic Station, NJ (US); Wonsuck Lee, Basking Ridge, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 12/258,888

(22) Filed: Oct. 27, 2008

(51) Int. Cl. G05B 11/01

(52) U.S. Cl. 340/310.11

(57) ABSTRACT

A remotely controllable power switch of an appliance and a method of employing a remotely controllable power switch of an appliance to control the overall load that an electric power distribution network bears. The method may include a method of employing a remotely controllable power switch of an appliance to compute the rate that a particular customer pays for electric power. In one embodiment, the remotely controllable power switch of an appliance includes: (1) a switching device coupled between an input and an output of the remotely controllable power switch of an appliance and (2) communication circuitry coupled to the switching device, addressable only by class and configured to receive a turn-off signal and turn off the switching device in response thereto.

### TECHNICAL FIELD OF THE INVENTION

The invention is directed, in general, to a remotely controllable power switch of an appliance and methods of employing a remotely controllable power switch of an appliance.

### BACKGROUND OF THE INVENTION

Maintaining electrical service during periods of peak demand causes significant problems for power utilities. Overloading an electric power distribution network can lead to brownouts or worse, blackouts. Not only do customers lose service, electrical generators or the electric power distribution network itself may be damaged.

### SUMMARY OF THE INVENTION

Various embodiments provide a remotely controllable power switch of an appliance. In one embodiment, the remotely controllable power switch of an appliance includes: (1) a switching device coupled between an input and an output of the remotely controllable power switch of an appliance and (2) communication circuitry coupled to the switching device, addressable only by class and configured to receive a turn-off signal and turn off the switching device in response thereto.

Another embodiment provides a method of employing a remotely controllable power switch of an appliance to control overall electric power distribution network load. In one embodiment, the method includes: (1) transmitting a turn-off signal to a class of remotely controllable power switches, the remotely controllable switches being addressable only by class, (2) thereby interrupting power only to appliances coupled to an electric power distribution network through the class of remotely controllable power switches and (3) providing power to remaining appliances through the electric power distribution network.

### BRIEF DESCRIPTION OF THE DRAWINGS

For a more complete understanding of the illustrative embodiments, reference is now made to the following descriptions taken in conjunction with the accompanying drawings, in which:

FIG. 1 is a block diagram of an electric power distribution network;

FIG. 2 is a block diagram of a first embodiment of a remotely controllable power switch of an appliance;

FIG. 3 is a block diagram of a second embodiment of a remotely controllable power switch of an appliance;

FIG. 4 is a block diagram of a third embodiment of a remotely controllable power switch of an appliance;

FIG. 5 is a flow diagram of one embodiment of a method of employing a remotely controllable power switch of an appliance to control overall electric power distribution network load; and

FIG. 6 is a flow diagram of one embodiment of a method of employing a remotely controllable power switch of an appliance to compute an electric power rate.

### DETAILED DESCRIPTION

In many cases, utilities urge industrial customers (factories, etc.) to conserve power during periods of high (e.g., “peak”) demand. Sometimes utilities appeal to residential customers through the local media to reduce their consumption. In the most extreme cases, utilities are forced to resort to rolling blackouts in which regions lose all of their power for a period of time. Laws have been proposed in some states that would allow utilities to set temperatures on residential thermostats. However, residential customers regard such control as highly invasive and are therefore mounting vehement resistance to such laws. Thus, other than appealing through the media, utilities have little ability to motivate their residential customers to moderate their usage.

It is recognized that while it may be necessary to “power” (maintain electric power service to) some appliances (as that term is defined below), powering other appliances is optional. It is also recognized that the person or persons associated with a particular premises are likely best suited to determine which appliances are more important to power than others. It is further recognized that a mechanism may be provided by which the person or persons may indicate their determination and further by which power may be remotely interrupted, particularly during times of high or peak demand.

Accordingly, various embodiments of remotely controllable power switch of an appliance will be described herein. Further, various embodiments of methods of employing a remotely controllable power switch of an appliance to control the overall load that an electric power distribution network bears, compute the rate that a particular customer pays for electric power, or both, will also be described herein. Various of the embodiments allow an electric power utility or the owner or operator of a site (as that term is defined below) to turn off appliances for which the powering thereof has been predetermined to be optional during times of high or peak demand. Various of the embodiments allow the owner or operator to turn off certain appliances located at their site that have been predetermined as being optionally disablable to decrease their electric power costs.

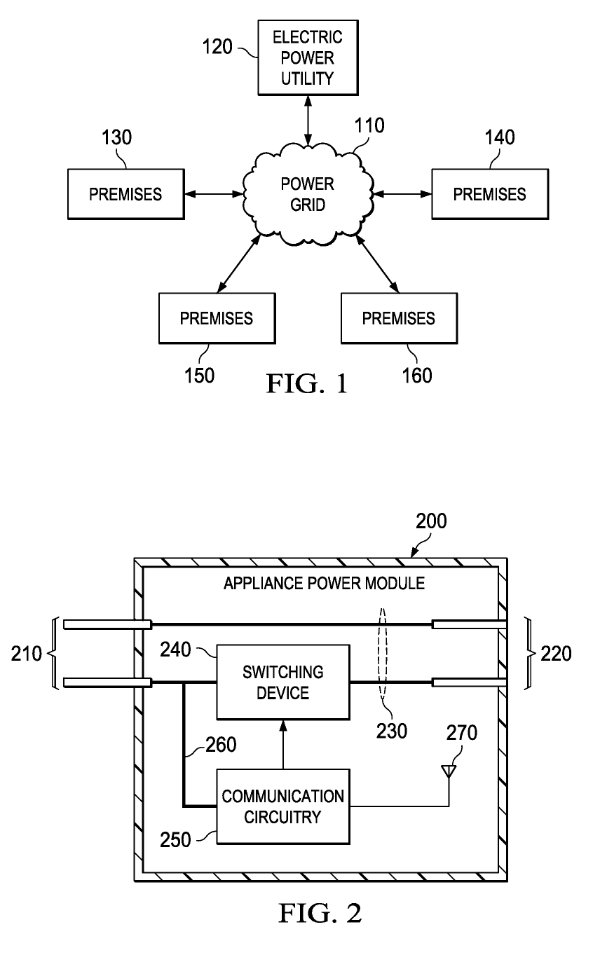

FIG. 1 is a block diagram of an electric power distribution network 110. An electric power distribution network is defined as a network of conductors that connects one or more sources of electrical power to multiple premises. Electric power distribution networks may take the form of commercial electric power distribution networks (colloquially called power grids) and site-specific electric power distribution networks. An “appliance” is any electrical load that derives its power from an electric power distribution network. An appliance therefore includes electronic devices, motors, light bulbs, transformers and any other conventional or later-developed electrical load.

A commercial electric power distribution network includes a network of electric power transmission and distribution lines and connects one or more commercial electric power generating plants with a relatively large number of residential and commercial customers over a given geographic area, typically over 100 square miles. An electric power utility operates the one or more commercial electric power generating plants and bills the residential and commercial customers for the electric power they consume.

A site-specific electric power distribution network receives electric power from a commercial electric power distribution network and employs distribution lines to distribute the electric power over a commercial site (e.g., one or more office buildings or a factory). The owner or operator of the site (e.g., a landlord or a particular commercial enterprise) typically pays an electric power utility for the electric power received by the site-specific electric power distribution network from the commercial electric power distribution network.

FIG. 1 shows an electric power utility 120 coupled to the electric power distribution network 110. Various premises 130, 140, 150, 160 are also coupled to the electric power distribution network 110. If the electric power distribution network 110 is a commercial electric power distribution network, one or more electric power generating plants of the electric power utility 120 are coupled to the electric power distribution network 110, and the premises 130, 140, 150, 160 take the form of separate residential or commercial premises with which separate customers are associated.

If the electric power distribution network 110 is a site-specific electric power distribution network, the commercial electric power distribution network of the electric power utility 120 is coupled to the electric power distribution network 110, and the premises 130, 140, 150, 160 take the form of whole buildings or portions thereof, specifically, floors, or portions thereof, including office suites or individual offices.

FIG. 2 is a block diagram of a first embodiment of a remotely controllable power switch of an appliance constructed according to the principles of the invention. The first embodiment takes the form of an appliance power module 200.

The module 200 includes an input 210. In the illustrated embodiment of the module 200, the input 210 takes the form of a plug. The plug may be a NEMA 1-15 (North American 15 A/125 V ungrounded) plug, a NEMA 5-15 (North American 15 A/125 V grounded) plug or a plug of any other type, including those used in countries other than the United States and voltages other than a nominal 125 V.

The module 200 also includes an output 220. In the illustrated embodiment of the module 200, the output 220 takes the form of a receptacle. The receptacle may be configured to receive a NEMA 1-15 plug, a NEMA 5-15 plug or a plug of any other type, including those used in countries other than the United States and voltages other than a nominal 125 V.

Conductors 230 couple the input 210 to the output 220 through a switching device 240. In the illustrated embodiment, the switching device 240 is a solid-state switching device, e.g., a power transistor. However, the invention encompasses switching devices of any conventional or later-developed type whatsoever, including relays and other types of electrical or electromechanical switches. It should also be noted that the switching device 240 may be found in other embodiments of the remotely controllable power switch of an appliance, including second and third embodiments to be illustrated and described below.

Communication circuitry 250 is coupled to the switching device 240. The communication circuitry 250 is addressable, meaning that it responds only to signals having one or more certain characteristics (e.g., amplitude, frequency, phase, pulse shape or digital code) and not to signals lacking those one or more certain characteristics. However, the communication circuitry 250 is addressable only by class, meaning that the communication circuitry 250 is neither unique, nor does it have a unique code associated with it. Instead, the communication circuitry 250 is one of a class of like units of communication circuitry that is addressable only as a class, and not individually. Individually addressable communication circuitry, for example that comply with the well-known X10 home security standard, are outside of the scope of the invention and are expressly disclaimed. The communication circuitry 250 is configured to receive a turn-off signal and turn off the switching device 240 in response thereto. In another embodiment, the communication circuitry 250 is configured to receive a turn-on signal and turn on the switching device 240 in response thereto. In still other embodiments, the communication circuitry 250 is configured to transmit a current draw signal. In one embodiment, the current draw signal indicates merely whether the appliance power module 200 is turned on or turned off. In an alternative embodiment, the current draw signal indicates the amount of current drawn through the appliance power module 200.

In one embodiment, the current draw signal enables an electric power utility to compute an electric power rate for a corresponding customer. The electric power rate may be based on the day of the week, the time of the day or the amount of time that the current draw signal indicates that the remotely controllable power switch of an appliance is turned on. In another embodiment, the current draw signal allows the electric power utility to compute an electric power rate based on the amount of current drawn through the appliance power module 200. The electric power rate may also be based on the day of the week, the time of the day or the amount of time that the current draw signal indicates that the appliance power module 200 is turned on.

It should also be noted that the communication circuitry 250 may be found in other embodiments of the remotely controllable power switch of an appliance, including second and third embodiments to be illustrated and described below.

In one embodiment, an input of the communication circuitry 250 is coupled to the input 210. A conductor 260 may be used to couple the input of the communication circuitry 250 to the input 210. In this embodiment, the communication circuitry 250 is configured to receive signals, including the turn-off and turn-on signals, through an electric power distribution network (not shown in FIG. 2, but referenced as 110 in FIG. 1) couplable to the input 210. In this embodiment, the communication circuitry 250 is capable of receiving signals when appliance power module 200 is plugged into the electric power distribution network.

Those skilled in the pertinent art are aware that signals can be communicated via power lines and thus over an electric power distribution network to any electronic device, including various embodiments of the remotely controllable power switch of an appliance described herein. Various technologies exist for power line communication (PLC), also known as power line carrier, mains communication, power line telecom (PLT) or power line networking (PLN). As just one example, U.S. Pat. No. 5,777,769, which issued to Coutinho on Jul. 7, 1998, entitled “Device and Method for Providing High Speed Data Transfer Through a Drop Line of a Power Line Carrier Communication System” commonly assigned with the invention and incorporated herein by reference, teaches PLC.

In an alternative embodiment, the communication circuitry 250 includes an antenna 270. In this embodiment, the communication circuitry 250 is configured to receive signals, including the turn-on and turn-off signals, wirelessly. In one more specific embodiment, the communication circuitry 250 is configured to receive signals at any time, irrespective of whether or not the appliance power module 200 is plugged into the electric power distribution network. In this embodiment, the communication circuitry 250 is battery-powered. In the illustrated embodiment, however, the communication circuitry 250 draws its power from the input 210, in which case the communication circuitry 250 is capable of receiving signals when appliance power module 200 is plugged into the electric power distribution network.

Those skilled in the pertinent art are also aware that signals can be communicated wirelessly via a host of conventional radio technologies, all of which fall within the scope of the invention. Later-developed radio technologies also fall within the scope of the invention.

The appliance power module 200 may take the form of a wall adapter and be embodied, for example, in a block-like (e.g., roughly cubical) housing as FIG. 2 graphically implies. This allows the input 110 (plug) of the appliance power module 200 to be plugged into a common household or office outlet. An appliance may then be plugged into the output 220 (receptacle) Of course, other housing sizes and shapes fall within the scope of the invention.

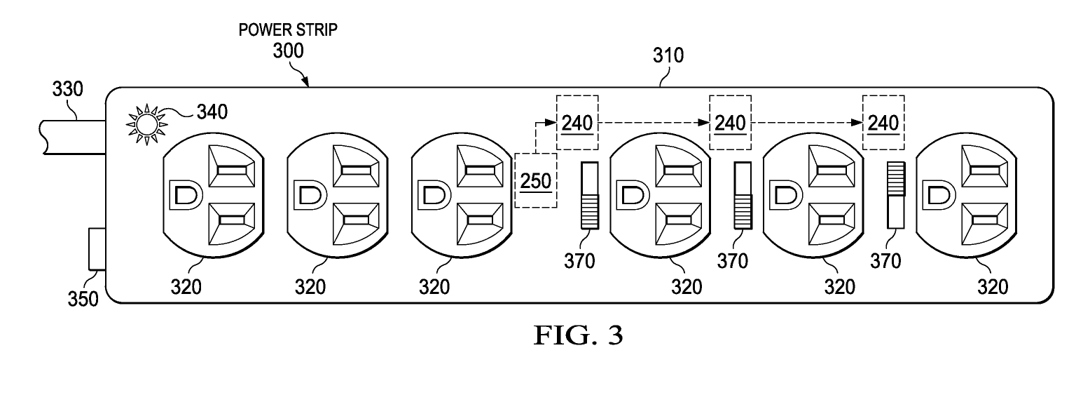

Accordingly, FIG. 3 is a block diagram of a second embodiment of a remotely controllable power switch of an appliance constructed according to the principles of the invention. The second embodiment takes the form of a power strip 300. The power strip 300 has an elongated body 310 to which are connected a plurality of outputs, namely receptacles 320. A power cord 330 allows the power strip 300 to be coupled to an electric power distribution network (not shown in FIG. 3). A status indicator lamp 340 may be included to indicate that the power strip 300 is powered, that the power strip 300 is properly grounded, that any surge protection that may attend the power strip 300 is functional or some other appropriate status. A fuse or breaker 350 may serve to protect the power strip 300 from overload.

As FIG. 3 shows, the power strip 300 includes one or more switching devices 240 each associated with one or more of the plurality of receptacles 320. In the specific embodiment of FIG. 3, three switching devices 240 correspond to three receptacles 320. Three other receptacles 320 do not have corresponding switching devices and are therefore coupled directly to the power cord 330 and assumed not to be remotely controllable. Thus, the power strip 300 of FIG. 3 can accommodate both appliances that are important to power during times of heavy demand and appliances are less important to power during times of heavy demand and that therefore may be remotely turned off.

FIG. 3 shows a single unit of the communication circuitry 250 coupled to the switching devices 240. Of course, each switching device 240 may be provided with its own unit of communication circuitry 250.

Mode switches 370 are also associated with each of the switching devices 240. In one embodiment, the mode switches 370 are opened to enable the switching devices 240 and render the associated receptacles 320 remotely controllable and closed to disable (e.g., bridge across) the switching devices 240 to render the associated receptacles unable to be remotely controlled.

In another embodiment, the mode switches 370 are opened to select a class for the receptacle. This allows appliances to be stratified into, e.g., three classes: those that are very important and therefore not remotely controllable, those that are not important and therefore readily disablable, and those in between that may be disabled, but perhaps only under more serious circumstances. If multiple classes are supported, the communication circuitry 250 is configured to discriminate between or among multiple types of turn-off and turn-on signals, for example, based on differences in amplitude, frequency, phase, pulse shape or digital code.

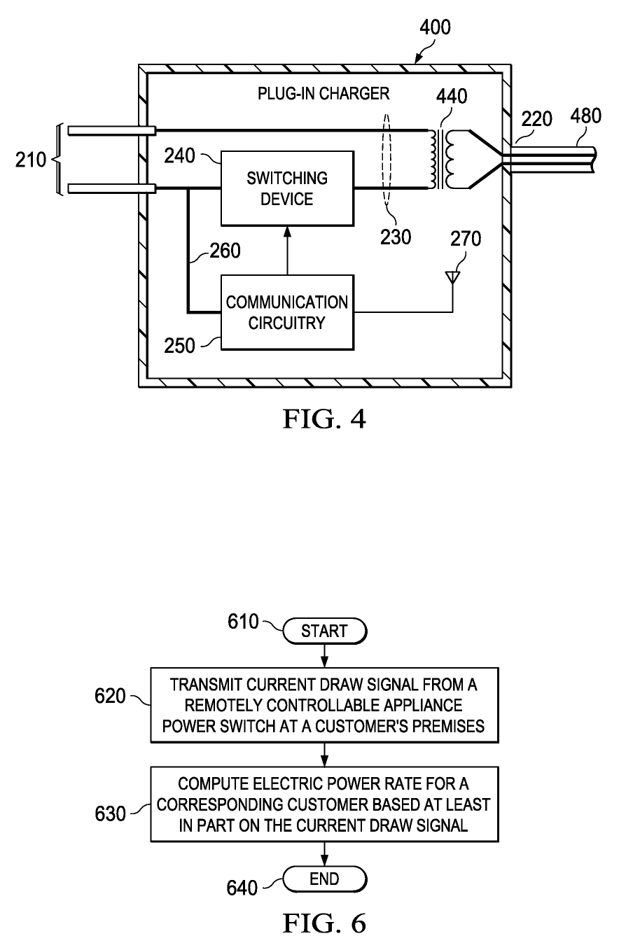

FIG. 4 is a block diagram of a third embodiment of a remotely controllable power switch of an appliance constructed according to the principles of the invention. Although many people are not aware of it, plug-in chargers (the kind that are widely used to provide relatively low-voltage power to electronic devices such as cell phones, cameras, personal digital assistants, games and the like) consume a small amount of power (one watt, more or less) even when nothing is coupled to their output. While such a small amount of power seems insignificant, millions of plug-in chargers are in use in the United States, not to mention the world. Many of these are habitually left plugged in and therefore account for a surprising fraction of the overall load an electric power distribution network must bear. Accordingly, a third embodiment of the remotely controllable power switch of an appliance takes the form of a plug-in charger 400.

The plug-in charger 400 contains may of the same elements as does the appliance power module 200 of FIG. 2, namely the input 210, the output 220, the conductors 230, the switching device 240 and the communication circuitry 250. The alternative conductor 260 or antenna 270 are also like those of FIG. 2. The conductors 230 are coupled to a primary winding of a transformer 440. A secondary winding of the transformer 440 is coupled to the output 220. In the embodiment of FIG. 4, the transformer 440 is a step-down transformer. Although FIG. 4 does not show such, the plug-in charger 400 may include a rectifier, yielding a direct current (DC) at the output 220, or lack a rectifier, yielding an alternating current (AC) at the output 220. A cord 480 has a connector (not shown) coupled to a distal end thereof which may be plugged into a device to provide power thereto.

According to the description of the various embodiments set forth above, an electric power utility can transmit a signal that has certain characteristics identifying it as a turn-off signal or a turn-on signal to a class of remotely controllable power switches. Various embodiments of methods of communicating with the remotely controllable power switches will now be described.

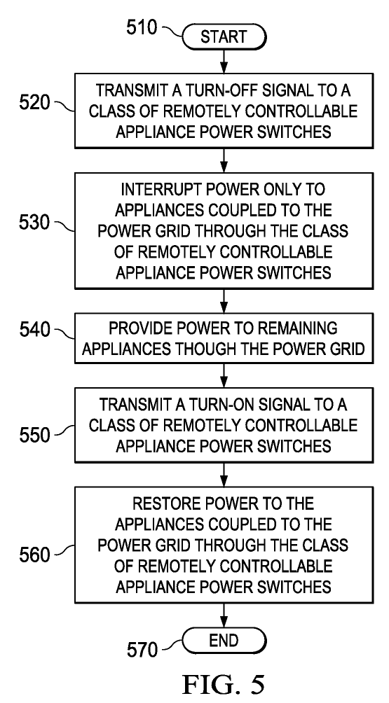

FIG. 5 is a flow diagram of one embodiment of a method of employing a remotely controllable power switch of an appliance to control overall electric power distribution network load. The method begins in a start step 510. In a step 520, a turn-off signal is transmitted to a class of remotely controllable power switches. The switches are addressable by class, not individually. In a step 530, power is thereby interrupted only to appliances coupled to the electric power distribution network through the class of remotely controllable power switches. In a step 540, power is provided to the remaining appliances through the electric power distribution network. In a step 550, a turn-on signal is transmitted to the class of remotely controllable power switches. Again, the switches are addressable by class, not individually. In a step 550, power is thereby restored to the appliances coupled to the electric power distribution network through the class of remotely controllable power switches. The method ends in an end step 570.

FIG. 6 is a flow diagram of one embodiment of a method of employing a remotely controllable power switch of an appliance to compute an electric power rate. The method begins in a start step 610. In a step 620, a current draw signal is transmitted from a remotely controllable power switch of an appliance at a customer's premises. In a step 630, an electric power rate for a corresponding customer is computed based at least in part on the current draw signal. In one embodiment, the current draw signal indicates merely whether the remotely controllable power switch of an appliance is turned on or turned off. In a more specific embodiment, the electric power rate is based on the day of the week, the time of the day or the amount of time that the current draw signal indicates that the remotely controllable power switch of an appliance is turned on. In an alternative embodiment, the current draw signal indicates the amount of current drawn through the remotely controllable power switch of an appliance. In a more specific embodiment, the electric power rate is based on the amount of current drawn through the remotely controllable power switch of an appliance. In a yet more specific embodiment, the electric power rate is also based on the day of the week, the time of the day or the amount of time that the current draw signal indicates that the remotely controllable power switch of an appliance is turned on. The method ends in an end step 640.

Those skilled in the art to which the invention relates will appreciate that other and further additions, deletions, substitutions and modifications may be made to the described embodiments without departing from the scope of the invention.

What is claimed is:

1. A remotely controllable power switch of an appliance, comprising:
a switching device coupled between an input and an output of said remotely controllable power switch of an appliance; and
communication circuitry controlling said switching device, and being configured to receive a turn-off signal through an electric power distribution line and to turn off said switching device in response thereto.

2. The remotely controllable power switch of an appliance as recited in claim 1 wherein said communication circuitry is further configured to receive a turn-on signal and turn on said switching device in response thereto.

3. The remotely controllable power switch of an appliance as recited in claim 1 wherein said input includes a plug and said output includes a receptacle.

4. The remotely controllable power switch of an appliance as recited in claim 3 wherein said switching device is a first switching device and said output is a first output and said remotely controllable power switch of an appliance further comprises a second switching device coupled between said input and a second output, said communication circuitry further coupled to said second switching device.

5. The remotely controllable power switch of an appliance as recited in claim 1 further comprising further outputs coupled directly to said input.

6. The remotely controllable power switch of an appliance as recited in claim 1 wherein said input includes a plug and said output includes a transformer.

7. A method of employing a, comprising:
transmitting a turn-off signal to remotely controllable power switches of a class of appliances through an electric power distribution network such that power of an electric power distribution network is interrupted to the appliances of the class by the remotely controllable power switches; and
thereby interrupting power only to appliances coupled to an electric power distribution network through the class of remotely controllable appliance power switches; and
simultaneously providing power to remaining appliances through said electric power distribution network.

8. The method as recited in claim 7 further comprising:
transmitting a turn-on signal to said class of remotely controllable power switches of appliances to restore power to said appliances via said electric power distribution network.

9. The method as recited in claim 7 wherein ones of said some of the remotely controllable power switches of appliances are incorporated in a selected one of:
an appliance power module,
a power strip, and
a plug-in charger.

10. The method as recited in claim 7 wherein said class is a first class and said method further comprises transmitting a turn-off signal to a second class of appliances.

11. The method as recited in claim 7 further comprising:
transmitting a current draw signal from one of said appliances to the network; and
computing an electric power rate for a customer corresponding to said one of said appliances based at least in part on said current draw signal.

12. The method as recited in claim 11 wherein said current draw signal indicates only whether said remotely controllable power switch of said one of said appliances is turned on or turned off.

13. The method as recited in claim 12 wherein said computing comprises computing said electric power rate based on one of:
a day of a week that said current draw signal indicates that said remotely controllable power switch of an appliance is turned on,
a time of a day that said current draw signal indicates that said remotely controllable power switch of an appliance is turned on, and
an amount of time that said current draw signal indicates that said remotely controllable power switch of an appliance is turned on.

14. The method as recited in claim 11 wherein said current draw signal indicates an amount of current drawn through said remotely controllable power switch of an appliance.

15. The method as recited in claim 14 wherein said computing comprises computing said electric power rate based on an amount of current drawn through said remotely controllable power switch of an appliance.

16. The method as recited in claim 15 wherein said computing further comprises further computing said electric power rate based on one of:
a day of a week that said current draw signal indicates that said remotely controllable power switch of an appliance is turned on,
a time of a day that said current draw signal indicates that said remotely controllable power switch of an appliance is turned on, and
an amount of time that said current draw signal indicates that said remotely controllable power switch of an appliance is turned on.
